(19) United States
(12) Patent Application Publication
(10) Pub. No.: US 2009/0142128 A1
(43) Pub. Date: Jun. 4, 2009

(54) Dry erase marker renewal device

(76) Inventor: Kurtis Johnson, Tallahassee, FL (US)

Correspondence Address: John Wiley Horton, Attorney;Pennington, Moore, Wilkinson, Bell & Dunbar, P.A., 2nd Floor, 215 S. Monroe St., Tallahassee, FL, 32301, US

(21) Appl. No.: 11/998,242

(22) Filed: Nov. 29, 2007

(51) Int. Cl. B43K 8/04

(52) U.S. Cl. 401/198

(57) ABSTRACT

A device for use in rejuvenating a marker to allow the flow of ink through the tip of the marker after it has become dried out. The device is comprised of an actuator and a reservoir. The actuator of the device comprises a receiver, a spray chamber and a threaded engagement for connection to the reservoir. The reservoir is configured to hold a volume of solvent. A solvent chamber, a conduit, a nozzle and a plurality of bellows make up the reservoir. As actuator and bellows are compressed solvent travels through the conduit and nozzle and into spray chamber spraying marker tip with solvent.

### BACKGROUND OF THE INVENTION

1. Field of the Invention

This invention relates to the field of marking devices. More specifically, the invention comprises a device for rejuvenating the tip of a dried out marker.

2. Description of the Related Art

Dry erase markers and whiteboards are becoming more readily used in classrooms and workplaces in lieu of chalk and chalkboards. Marker tips often dry out before the ink in the marker has been consumed. The cost of replacing dried out markers affects budgets for schools, employers and individuals. Therefore, lengthening the life of a marker would be advantageous.

As illustrated in FIG. 1, a typical prior art dry erase marker 10 is comprised of a body 12, neck 20, tip holder 16, tip 14 and cap 18. If cap 18 is left off of dry erase marker 10, tip 14 often becomes dry and the ink will no longer flow readily through tip 14. Tip 14 can also become dry while a user is writing with dry erase marker 10 on a whiteboard.

Renewal devices have not previously been used to rejuvenate dry erase markers 10. Typically, dry erase markers 10 are simply thrown away and new ones purchased. Additionally, a user may become frustrated when a marker runs out in the middle of writing, especially when there are no other markers in the area. A renewal device will ideally allow the user to quickly and efficiently renew the marker and continue writing, saving time, frustration and money. A renewal device could be placed on or around a writing surface on which dry erase markers are used. Additionally, a smaller, portable version of the renewal device could be used to transport the device in a user's pocket, briefcase, backpack or purse.

### BRIEF SUMMARY OF THE INVENTION

The present invention comprises a marker rejuvenator for renewing a marker when the tip becomes dry. The rejuvenator is primarily comprised of an actuator, a reservoir and a fluid dispersion nozzle. The actuator is preferably located proximate the reservoir. The actuator may be made separate from the reservoir for manufacturing convenience. In such a case, an engagement mechanism, such as a threaded engagement, attaches the actuator and reservoir.

The reservoir is configured to hold a certain volume of solvent at the base of the device. In the preferred embodiment of the present invention a extends upward from the base of the device traveling through the center of a bellows. The conduit ends at a nozzle. The actuator contains a spray chamber located proximate the nozzle. The spray chamber preferably includes a receiver configured to receive the marker tip.

To operate the device a user places a dry erase marker into the receiver. In the preferred embodiment, the neck of the marker contacts the tapered entry of the receiver. The tapered entry can contain an optional o-ring to seal the spray chamber into which the tip of the marker extends. Force applied by the user depresses the actuator and the bellows of the rejuvenator. Upon depressing the bellows the solvent travels through the conduit and out of the nozzle. The solvent is sprayed into the spray chamber where the tip is located. The tip is evenly coated with solvent, which allows ink to begin flowing through the tip again.

### BRIEF DESCRIPTION OF THE SEVERAL VIEWS OF THE DRAWINGS

FIG. 1 is a perspective view, showing a dry erase marker.

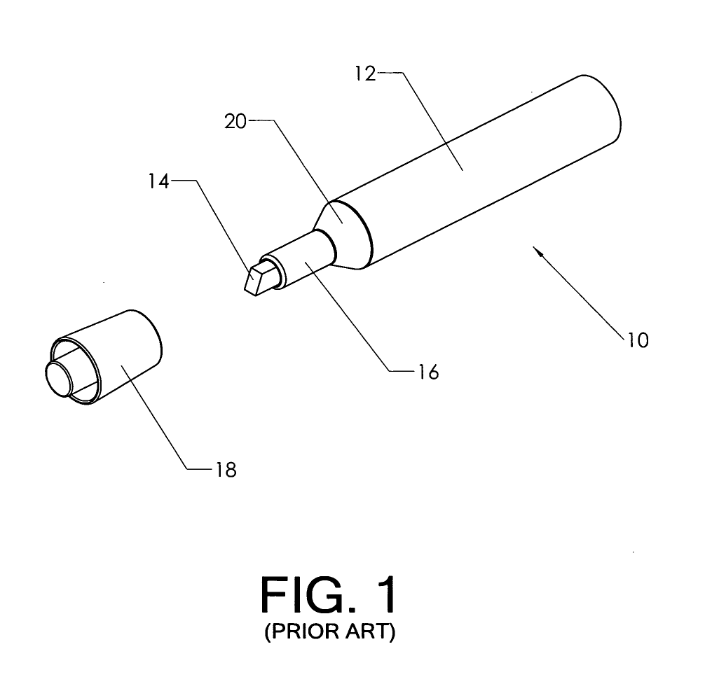

FIG. 2 is a perspective view, showing one embodiment of the present invention.

FIG. 3 is a sectioned perspective view, showing the present invention.

FIG. 4 is a sectioned perspective view, showing the present invention in operation with dry erase marker.

FIG. 5 is a sectioned perspective view, showing the present invention in operation with a dry erase marker.

FIG. 6 is a sectional view, showing an alternative embodiment of the present invention.

FIG. 7 is a perspective view, showing the reservoir detached and apart from the actuator.

FIG. 8 is a perspective view, showing the actuator detached and apart from the reservoir.

FIG. 9 is a sectional view, showing the top of the rejuvenator and an alternative embodiment of the present invention with an optional o-ring.

FIG. 10 is a perspective view, showing the present invention engaged with a whiteboard.

FIG. 11 is a sectioned perspective view, showing an alternate embodiment of the present invention.

### REFERENCE NUMERALS IN THE DRAWINGS

| | | | |
|---|---|---|---|
| 10 | dry erase marker | 12 | body |
| 14 | tip | 16 | tip holder |
| 18 | cap | 20 | neck |
| 22 | rejuvenator | 24 | reservoir |
| 26 | actuator | 28 | receiver |
| 30 | boss | 32 | outer reservoir wall |
| 34 | outer actuator wall | 36 | nozzle |
| 38 | conduit | 40 | bellows |
| 42 | threaded engagement | 44 | spray chamber |
| 46 | tapered entry | 48 | solvent |
| 50 | solvent chamber | 52 | clip |
| 54 | whiteboard | 56 | o-ring |
| 58 | male thread | 60 | female thread |
| 62 | clamp | 64 | spray chamber |
| 66 | nozzle | 68 | bellows |
| 70 | reservoir | 72 | conduit |
| 74 | actuator | 76 | receiving orifice |

### DETAILED DESCRIPTION OF THE INVENTION

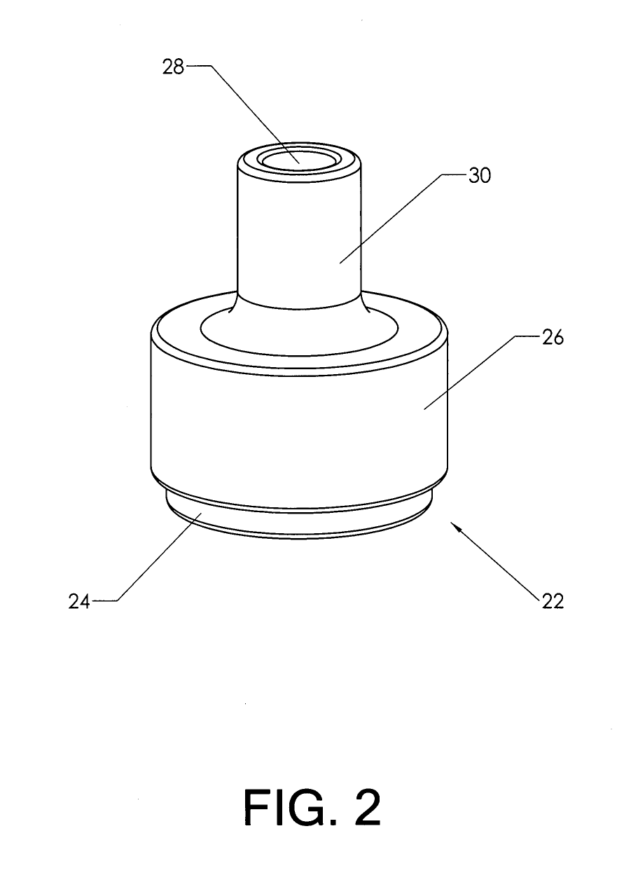

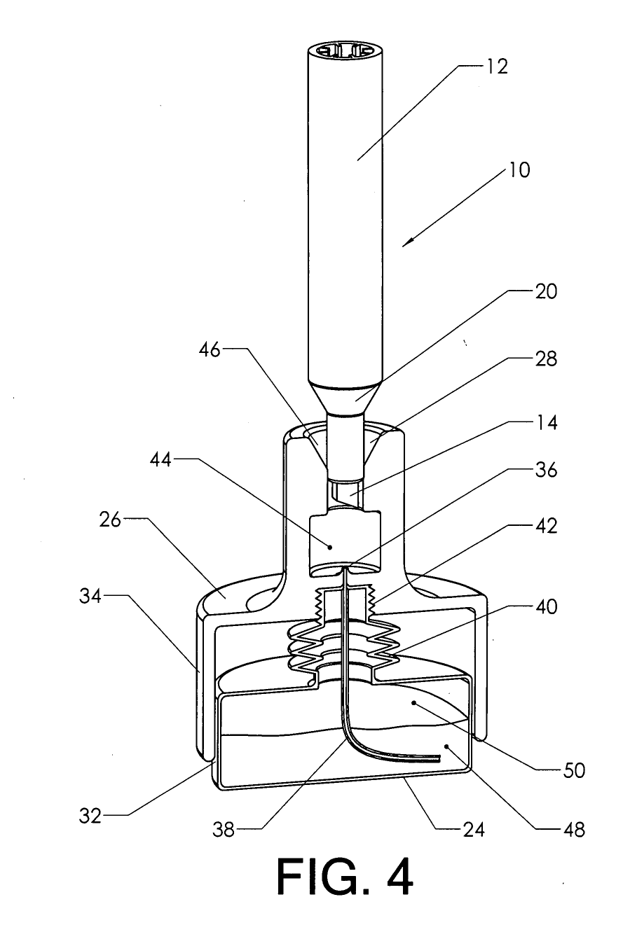

FIG. 2 shows a first embodiment of the present invention, rejuvenator 22, which may be used to revitalize a “dried out” dry erase marker. Rejuvenator 22 preferably comprises two detachable components—actuator 26 and reservoir 24. Actuator 26 includes boss 30 and receiver 28, which opens into the interior of boss 30. Receiver 28 is configured to accept tip 14 and neck 20 of dry erase marker 10 as seen in FIG. 4. Actuator 26 nests on top of reservoir 24 (in the orientation shown in the view) overlapping a portion of reservoir 24. In the present view, the top of reservoir 24 is covered by the bottom portion of actuator 26. Directional terms such as “top” and “bottom” will be understood to refer only to the orientation of the device as shown in the drawing views and not as limitations.

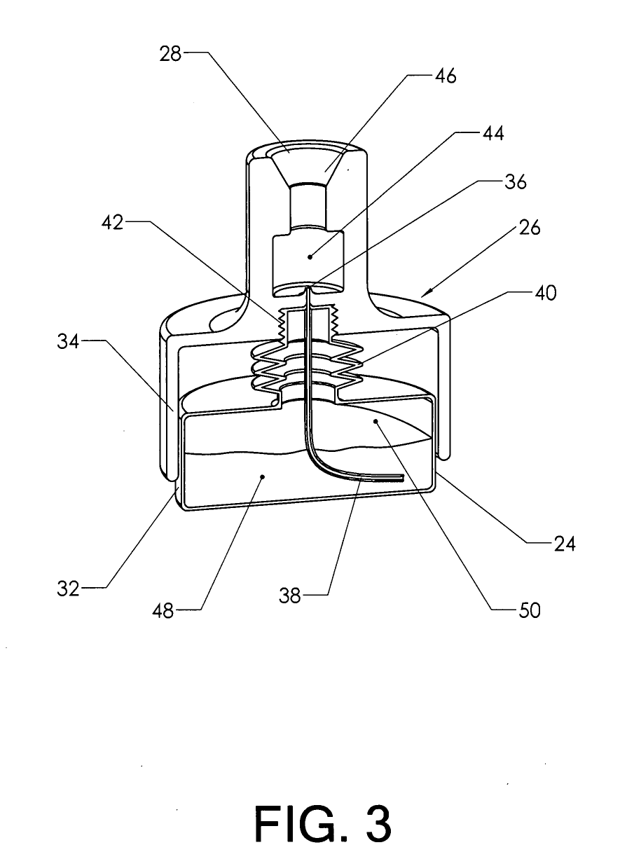

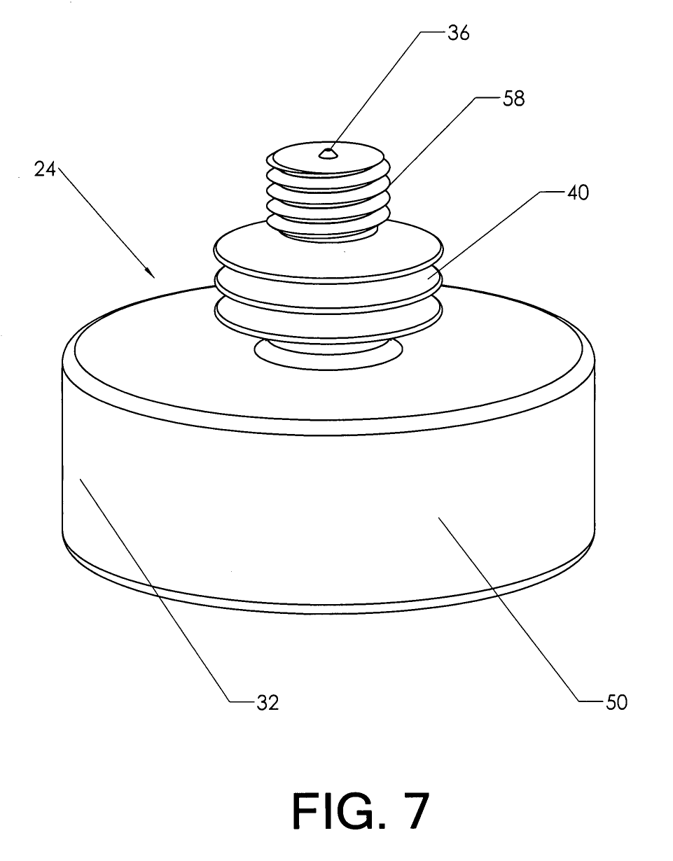

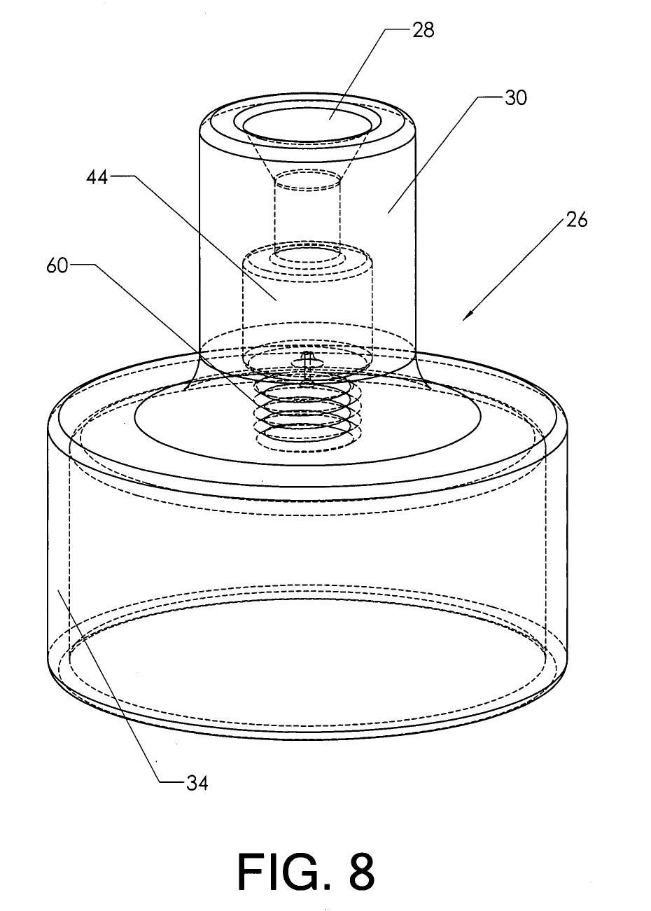

A section view of rejuvenator 22 is provided in FIG. 3. The reader will observe that actuator 26 and reservoir 24 are made as separate pieces in this embodiment. They are preferably connected by a detachable connection such as threaded engagement 42. As shown in FIG. 7 and FIG. 8, female thread 60 on actuator 26 engages male thread 58 on reservoir 24. There can be many different ways to attach actuator 26 and reservoir 24 together, however. For example, reservoir 24 could attach to actuator 26 by a snapping engagement or by a key turn engagement. Actuator 26 and reservoir 24 could also be made a single, integral piece. Thus, the details set out in this description should be viewed simply as one example selected from many possibilities.

Returning to FIG. 3, reservoir 24 contains solvent 48 within solvent chamber 50. Solvent 48 can be any fluid that when introduced to the tip of a dry erase marker will restart the flow of ink through the tip. The solvent can be carried to the spray chamber by a variety of devices. One approach is to use a conduit as shown. The base of conduit 38 is submerged into solvent 48 and extends upward away from the base of reservoir 24, through the middle of bellows 40 to nozzle 36. Bellows 40 extend upward from the top of solvent chamber 50. Bellows 40 are made of a material such that bellows 40 are compressed when pressure is applied. Bellows 40 reform to their original shape when pressure is released. An alternative embodiment of the present invention could comprise a spring mechanism located in place of bellows 40. One skilled in the art will recognize that the spring mechanism would act in the same manner as bellows 40.

Spray chamber 44 is provided proximate nozzle 36. Spray chamber 44 can be formed in any shape configured to accept tip 14 of dry erase marker 10. Spray chamber 44 opens upward to tapered entry 46 and receiver 28. The receiver and spray chamber can likewise be a single cavity of uniform shape, but the configuration shown in FIG. 3 is believed to be advantageous.

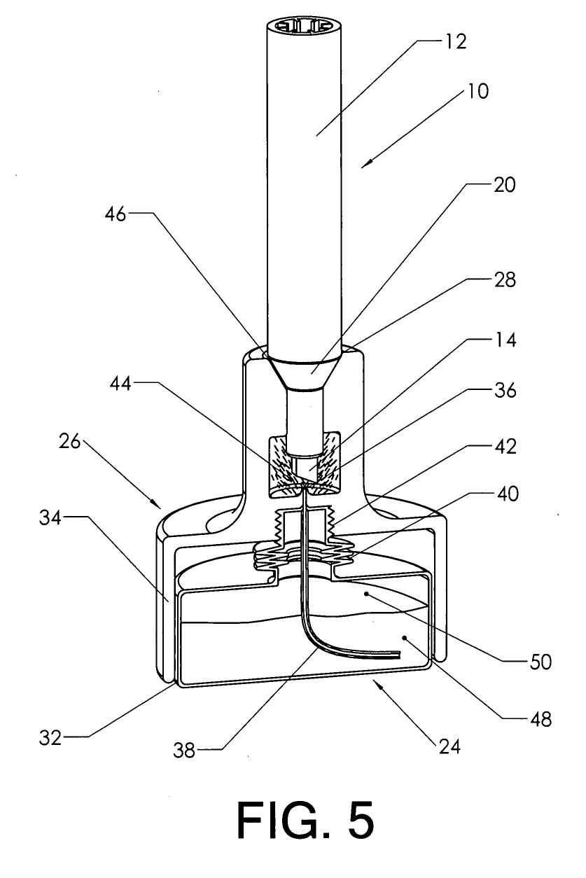

Turning to FIG. 4, the reader will observe that receiver 28 and tapered entry 46 accept tip 14 and neck 20 of dry erase marker 10. When a user exerts a force on dry erase marker 10 neck 20 of marker 10 contacts receiver 28 of actuator 26. When that force is applied to actuator 26 outer actuator wall 34 slides down vis-à-vis outer reservoir wall 32. This causes bellows 40 to compress, decreasing the total volume of solvent chamber 50, as seen in FIG. 5. The compression exerts pressure on the top of solvent 48 and causes solvent 48 to travel through conduit 38. Solvent 48 reaches nozzle 36 and disperses through nozzle 36 into spray chamber 44 as a mist, stream or spray. When tip 14 of dry erase marker 10 is inserted as shown the solvent will soak tip 14, thereby allowing the ink to begin to reflow. The terms “mist,” “stream,” and “spray” may be used interchangeably throughout to describe the discharge of solvent from the reservoir to the tip of the marker. The reader should understand that the solvent may be discharged at various flow conditions. The term “spray” is intended to be inclusive of any such flow condition in which solvent is discharged through an orifice.

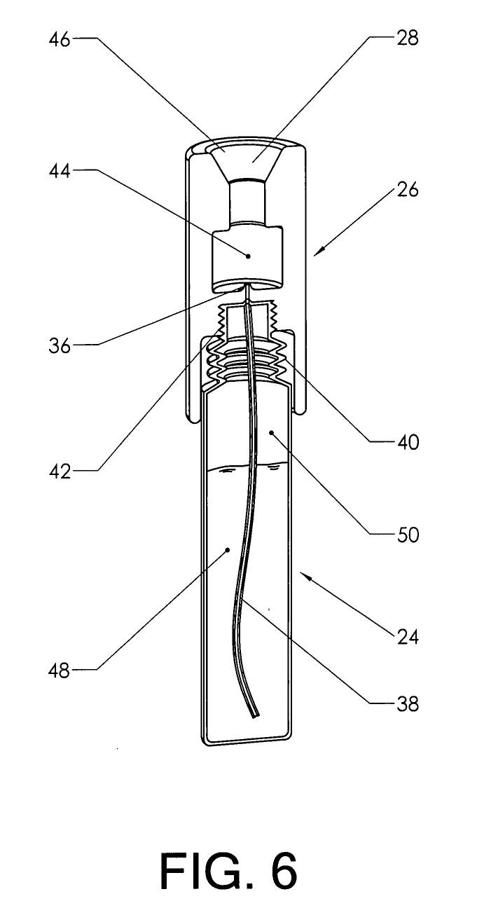

Another embodiment of the present invention is illustrated in FIG. 6. In this embodiment, the width of actuator 26 is only slightly wider than the width of receiver 28. Because of the narrow dimensions of actuator 26 and reservoir 24, rejuvenator 22 is approximately the size of dry erase marker 10 but operates in the same manner as the larger version. This embodiment allows the user to easily transport rejuvenator 22 in a pocket, backpack, briefcase or purse, which is a good example of the same structure being realized in a very different shape.

FIGS. 7 and 8 show the embodiment originally presented in FIG. 2. As the reader will observe in FIG. 7 and FIG. 8, reservoir 24 can be detached from actuator 26. This allows a user to replace reservoir 24 or refill reservoir 24 with solvent 48. FIG. 7 illustrates reservoir 24 independent of actuator 26. Nozzle 36 rests on top of male thread 58. When solvent chamber 50 is empty, reservoir 24 can be refilled with solvent 48 by removing nozzle 36 and pouring solvent 48 into the opening. Alternatively, the entire reservoir 24 could be replaced. Turning to FIG. 8, the reader will appreciate how male thread 58 of reservoir 24 engages female thread 60 of actuator 26.

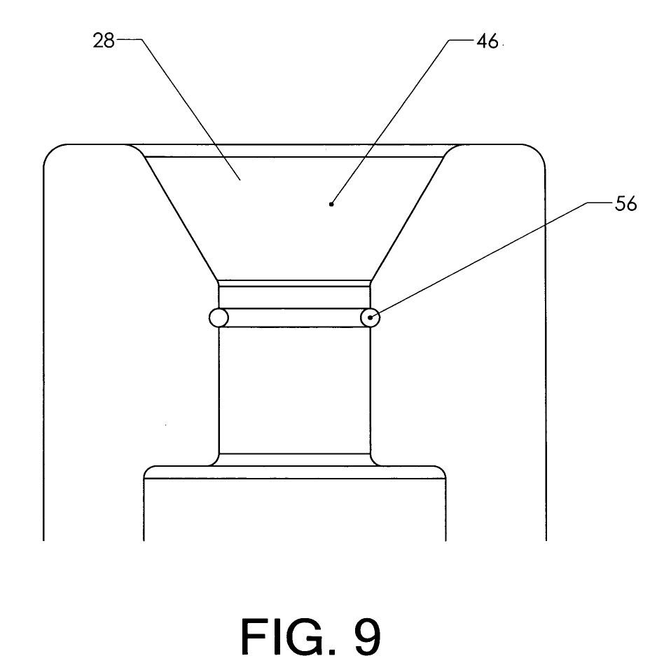

Still another alternative embodiment of the present invention is shown in FIG. 9. As the reader will observe, an optional o-ring 56 can be installed at the base of tapered entry 46 in order to seal the spray chamber 44 upon entry of tip 14 into receiver 28. The sealing of spray chamber 44 ensures that solvent 48 does not escape from spray chamber 44 and that only tip 14 of dry erase marker 10 contacts solvent 48. It may be necessary in this embodiment to install a lateral vent, or similar means, to allow air to escape actuator 26.

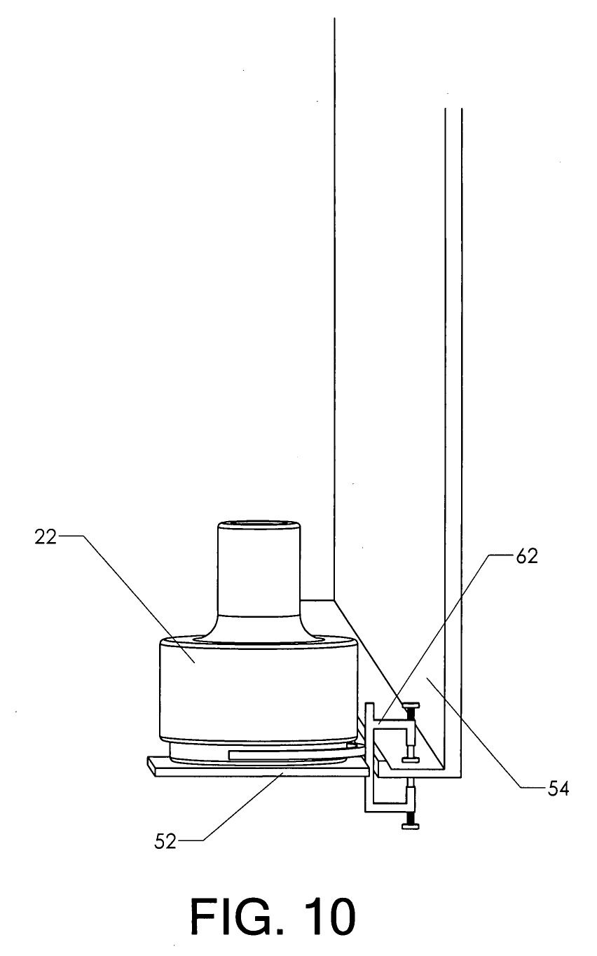

Yet another alternative embodiment of the present invention is shown in FIG. 10. Clip 52 can attach to the base of rejuvenator 22 in order to engage whiteboard 54 or some other suitable surface. In this embodiment, clamp 62 is used to attach rejuvenator 22 to the ledge of whiteboard 54. FIG. 10 is just one example selected from many possibilities of a means of connecting rejuvenator 22 to whiteboard 54.

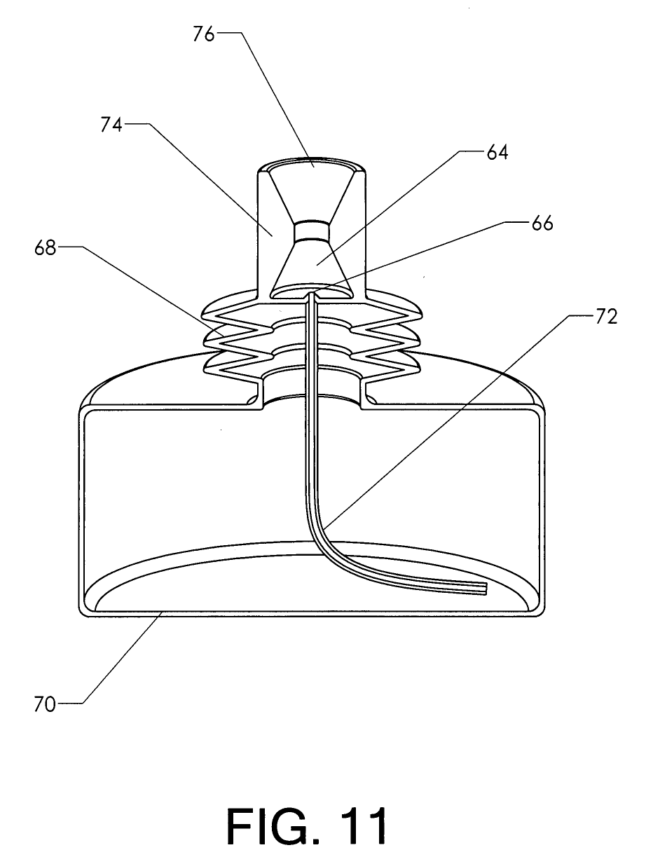

Another embodiment of the present invention is illustrated in FIG. 11. In this embodiment, actuator 74 and reservoir 70 are a single, unified component joined by bellows 68. Actuator 74 has receiving orifice 76 for receiving the tip of the marker. Nozzle 66 is provided at the base of spray chamber 64. Conduit 72 extends from the bottom of reservoir 70 to nozzle 66. As with the previous embodiment, when actuator 74 is pressed downward (toward reservoir 70) the solvent contained within reservoir 70 is pressurized. The pressurized solvent is forced up conduit 70 and through nozzle 66 where it is sprayed into spray chamber 64. Actuator 74 may be pressed down by contact with the marker (when the marker is inserted through receiving orifice 76) or independently (such as by applying a downward force directly on actuator 74 with the user's hand).

The preceding description contains significant detail regarding the novel aspects of the present invention. It should not be construed, however, as limiting the scope of the invention but rather as providing illustrations of the preferred embodiments of the invention. As an example, reservoir 24 and actuator 26 could be formed into many different shapes or sizes. In addition, other devices may be used to pressurize the solvent. In one embodiment, bellows 40 could be replaced by a pump mechanism similar to those found in spray bottles. Alternatively, the solvent may be pre-pressurized as an aerosol with a carrier or gas or may be pressurized by the consumer with assistance of a pressurized carbon dioxide cartridge or other device. Furthermore, colored dyes or other additives may be added to the solvent (such as a blue dye for use with blue markers). Such variations would not alter the function of the invention. Thus, the scope of the invention should be fixed by the following claims, rather than by the examples given.

Having described my invention, I claim:

1. A device, for allowing a user to rejuvenate the flow of ink through a marker having a tip, a neck and a body by wetting said tip of said marker with a solvent comprising:
a. an actuator, having a receiver adapted to accept said tip of said marker and a spray chamber fluidly connected with said receiver;
b. a reservoir, having a solvent chamber configured to hold a volume of said solvent, said reservoir being fluidly connected with said spray chamber; and
c. wherein said device is configured to spray said tip of said marker with said solvent when said tip of said marker is pressed into said receiver.

2. A device as recited in claim 1, wherein said receiver further comprises a tapered entry.

3. A device as recited in claim 1, wherein said receiver further comprises an o-ring.

4. A device as recited in claim 1, wherein said reservoir further comprises a conduit, a nozzle and a plurality of bellows.

5. A device as recited in claim 4, further comprising a clip for attaching said device to an object.

6. A device as recited in claim 1, wherein said actuator further comprises an outer actuator wall, wherein said outer actuator wall covers and overlaps a portion of said reservoir.

7. A device as recited in claim 6, wherein said outer actuator wall has a larger diameter than said receiver.

8. A device as recited in claim 6, wherein said outer actuator wall has substantially the same diameter as said receiver.

9. A device as recited in claim 1, wherein said reservoir further comprises a male thread and said actuator further comprises a female thread wherein said male thread and said female thread connect said reservoir to said actuator.

10. A device for rejuvenating the flow of ink through a marker, said marker having a tip, a neck and a body, by wetting said tip of said marker with a solvent, comprising:
a. a receiving orifice adapted to accept said tip of said marker,
b. a spray chamber fluidly connected with said receiving orifice;
c. a reservoir, having a solvent chamber configured to hold a volume of said solvent, said reservoir being fluidly connected with said spray chamber; and
d. an actuator configured to pressurize said solvent such that said solvent passes from said reservoir into said spray chamber, thereby wetting said tip of said marker.

11. The device of claim 10, wherein said actuator is adapted to pressurize said solvent when said actuator moves from a first position to a second position.

12. The device of claim 11, wherein said actuator is configured to move from said first position to said second position when said marker tip is inserted into said receiving orifice and contact is made between said marker and said device.

13. A device as recited in claim 10, wherein said reservoir further comprises a plurality of bellows.

14. A device as recited in claim 10, further comprising a clip for attaching said device to an object.

15. A device as recited in claim 10, wherein said actuator further comprises an outer actuator wall, wherein said outer actuator wall covers and overlaps a portion of said reservoir.

16. A device as recited in claim 10, wherein said outer actuator wall has a larger diameter than said receiver.

17. A device for allowing a user to rejuvenate the flow of ink through a marker, having a tip, a neck and a body, by wetting said tip of said marker with a solvent comprising:
a. an actuator, having a receiver adapted to accept said tip of said marker and a spray chamber fluidly connected with said receiver;
b. a reservoir, having a solvent chamber configured to hold a volume of said solvent and a nozzle; and
c. wherein said device is configured to pressurize said solvent so that said solvent discharges through said nozzle and wets said tip.

18. A device as recited in claim 17, wherein said solvent chamber is pressurized by said user applying a force to said actuator.

19. A device as recited in claim 18, wherein said force is applied by said tip of said marker coming in contact with said receiver of said actuator.
